(19) United States
(12) Patent Application Publication
(10) Pub. No.: US 2020/0099262 A1
(43) Pub. Date: Mar. 26, 2020

(54) POLYPHASE CLAW POLE MOTOR

(71) Applicant: NSK LTD., Tokyo (JP)

(72) Inventor: Isamu NITTA, Fujisawa-shi (JP)

(73) Assignee: NSK LTD., Tokyo (JP)

(21) Appl. No.: 16/610,334

(22) PCT Filed: May 18, 2018
(86) PCT No.: PCT/JP2018/019315

§ 371 Date: Nov. 1, 2019

(30) Foreign Application Priority Data
Jun. 15, 2017 (JP) 2017-117864

(51) Int. Cl. H02K 1/14; H02K 21/14; H02K 7/08

(52) U.S. Cl. CPC H02K 1/145; H02K 7/083; H02K 21/145

(57) ABSTRACT

A polyphase claw pole motor includes: a plurality of claw poles each having a plurality of claws (31) having a pole surface (31a) that faces a rotator (10) and a radial yoke part (32) that extends from the claws (31) toward an outer contour of the claw pole, the claw poles being laminated in an axial direction so as to form an inner peripheral stator part (3); a toroidal coil (4) arranged in a gap between the respective yoke parts (32) of adjacent claw poles (31); and outer peripheral yokes (50) that are circumferentially arranged on an outer side of the inner peripheral stator part (3) so as to form an outer peripheral stator part (5). The claw poles (30) are each formed of a magnetic-molded product formed by compressing magnetic powder with a surface of such powder being electrically insulated, and the outer peripheral yokes (50) are each formed of soft magnetic laminated plates. The polyphase claw pole motor further includes first positioning means (7) for positioning each of the outer peripheral yokes (50) at a predetermined position.

### TECHNICAL FIELD

The present invention relates to a polyphase claw pole motor.

### BACKGROUND ART

Conventionally, a polyphase claw pole type motor as shown in FIG. 25 has been known, wherein claws 110 of claw poles (a first claw pole 109A and a second claw pole 109B), a radial yoke part (a portion of a yoke which extends radially) 111, and an outer peripheral yoke (a portion of the yoke which is located at an outer periphery of the motor) 112 are formed of compressed-powder cores, with a toroidal coil being axially sandwiched therebetween (see, for example, Patent Document 1). In the motor having the above-mentioned configuration, the cross-sectional area of a magnetic path can be increased as compared to claws of a bent iron plate.

In general, the compressed-powder core advantageously has three-dimensional, non-directional magnetic properties. Thus, the use of the compressed-powder core for claws and radial yoke parts near the claws, which are desired to extend in three dimensions, is advantageous in terms of magnetic properties.

Further, a polyphase claw pole motor having claws formed by circumferential ring-like laminated cores that are formed of soft magnetic plates laminated in an axial direction has also been disclosed (see, for example, Patent Document 2). In Patent Document 2, although the claws are joined together, holes corresponding to interpolar spaces are provided so as to increase magnetic resistance, whereby pseudo-claws are formed.

However, since the polyphase claw pole motor disclosed in Patent Document 1 uses the compressed-powder core that is expensive and has poor magnetic properties as a material for the magnetic path other than an air gap, the amount of interlinkage magnetic flux is small and the material cost is high.

On the other hand, the polyphase claw pole motor disclosed in Patent Document 2 has a problem in that, when an alternating magnetic flux is caused to flow in the laminating direction of magnetic steel sheets, an insulating layer becomes parallel to the path of an eddy current and such current therefore cannot be avoided, and this results in an increase in core loss (increase in the eddy current).

In order to solve the above problems, the inventors of the present application have conceived of a polyphase claw pole motor having a novel configuration. More specifically, for example, part of a radial yoke part and an outer peripheral yoke are formed of a core constituted by non-directional magnetic steel sheets laminated in a tangential (circumferential) direction and a toroidal coil is enclosed by the laminated core in both an axial direction and a radial direction.

### CITATION LIST

### Patent Document

Patent Document 1: JP4878183 B

Patent Document 2: JP2014-233189 A

### SUMMARY

### Technical Problem

However, the above-mentioned configuration may disadvantageously increase the number of components constituting the outer peripheral yoke and thus complicate its assembly.

In view of the above circumstances, an object of the present invention is to provide a polyphase claw pole motor having a configuration in which a claw is formed of a compressed-powder core with a reduced magnetic resistance and reduced eddy current loss, while achieving a less-complicated assembly.

### Solution to Problem

A polyphase claw pole motor according to an aspect of the present invention includes a plurality of claw poles each having a plurality of claws having a pole surface that extends in an axial direction and faces a rotator with a minute gap therebetween, and a radial yoke part that extends from the claws toward an outer contour of the claw pole, the claw poles being laminated in the axial direction so as to form an inner peripheral stator part with the respective claws of adjacent claw poles being alternately arranged in a circumferential direction and the respective radial yoke parts of the adjacent claw poles facing each other in the axial direction; a toroidal coil arranged in a gap between the respective yoke parts of the adjacent claw poles; and a plurality of outer peripheral yokes circumferentially arranged on an outer side of the inner peripheral stator part so as to form an outer peripheral stator part, wherein the claw poles are each formed of a magnetic-molded product formed by compressing magnetic powder with a surface of such powder being electrically insulated, and the outer peripheral yokes are each formed of soft magnetic laminated plates, and wherein the polyphase claw pole motor further comprises first positioning means for positioning each of the outer peripheral yokes at a predetermined position.

According to the present aspect, by forming the outer peripheral yoke and the radial yoke part near the outer peripheral yoke using a core formed by laminating non-directional magnetic steel sheets in a tangential direction, a high output, a low core loss and a low material cost can be achieved. More specifically, when a compressed-powder core is used as a material for a magnetic path, the magnetic flux density becomes relatively small, and preparation of the outer peripheral yoke which rotates around the outer periphery of the coil and the radial yoke part near the outer peripheral yokel using the compressed-powder core causes poor magnetic permeability. Further, the use of the compressed-powder core, which has a poor core loss characteristic in a low frequency band, could lead to a low output, a high core loss and a high material cost. In the present aspect, by forming part of the radial yoke part and the outer peripheral yoke using a core formed by laminating the non-directional magnetic steel sheets in the tangential direction and enclosing the toroidal coil in the axial direction and the radial direction, it is possible to achieve a high output, a low core loss and a low material cost.

In addition, according to the present aspect, the first positioning means can position each of the outer peripheral yokes at a predetermined position. Thus, even if the number of components forming the outer peripheral yokes is large, it is possible to prevent its assembly from being complicated.

The polyphase claw pole motor according to the above aspect may further include second positioning means for positioning each of the claw poles at a predetermined position.

In the polyphase claw pole motor according to the above aspect, the second positioning means may be an interposed member located in a gap between at least part of claw shapes of the claw poles, and the interposed member may position the claw poles by being in contact with each claw that faces each other in the axial direction.

In the polyphase claw pole motor according to the above aspect, the interposed member may be a non-magnetic and insulating member.

In the polyphase claw pole motor according to the above aspect, the interposed member may be an insert-molded product including the magnetic-molded product as an insert.

In the polyphase claw pole motor according to the above aspect, the toroidal coil may be a coil formed by alpha winding and the interposed member may be an insert-molded product including the toroidal coil as an insert.

In the polyphase claw pole motor according the above aspect, the toroidal coil may be configured from a wire wound around the insert-molded product.

In the polyphase claw pole motor according to the above aspect, the interposed member may have a structure in which, in a state where adjacent interposed members are in contact with each other, the interposed members position the magnetic-molded product of another layer.

In the polyphase claw pole motor according to the above aspect, the first positioning means may be in contact with an outer periphery and circumferential end surfaces of each of the plurality of outer peripheral yokes, the first positioning means may have a shape that defines part of a ring-like shape, and a plurality of such first positioning members may be combined with each other to form the ring-like shape.

In the polyphase claw pole motor according to the above aspect, the plurality of first positioning means, when combined with each other, may sandwich the magnetic-molded product in the vicinity of a center thereof, the magnetic-molded product being positioned by the second positioning means.

In the polyphase claw pole motor according to the above aspect, the plurality of first positioning means may each have a shape that allows approximately half the plurality of outer peripheral yokes to be positioned and arranged in a semi-ring-like form and a pair of the first positioning means may be combined so as to sandwich the magnetic-molded product positioned by the second positioning means.

In the polyphase claw pole motor according to the above aspect, contact portions in a circumferential direction of the combined first positioning means may be provided with a groove and a coil lead wire from the toroidal coil may be drawn out from the groove.

In the polyphase claw pole motor according to the above aspect, the first positioning means may be a component of a bearing support structure for supporting a bearing.

In the polyphase claw pole motor according to the above aspect, an outer peripheral surface of the claw pole which is to be in contact with the outer peripheral yoke may extend along an extending direction of the claws and have a constricting shape that is tapered or stepped so as to form an inner circumferentially engaging form.

### Advantageous Effects of Invention

According to the present invention, it is possible to provide a polyphase claw pole motor in which claws are formed of a compressed-powder core with reduced magnetic resistance and reduced eddy current loss, while achieving a less-complicated assembly.

### BRIEF DESCRIPTION OF DRAWINGS

FIG. 1 is a perspective view showing an inner peripheral stator part formed by joining three pairs of claw poles.

FIG. 2 is a perspective view showing a state in which one outer peripheral yoke is brought into close contact with the inner peripheral stator part shown in FIG. 1 in a close contact manner.

FIG. 3 is a perspective view showing a stator in which all outer peripheral yokes are arranged around the inner peripheral stator part and wire ends of toroidal coils are drawn out therefrom.

FIG. 4 is a diagram showing a configuration of one of a pair of claw poles according to a first embodiment of the present invention.

FIG. 5 is a diagram showing a configuration of the other one of the pair of claw poles according to the first embodiment of the present invention.

FIG. 6 is a front view of a polyphase claw pole motor.

FIG. 7 is a diagram showing a cross-sectional structure taken along line VII-VII of FIG. 6.

FIG. 8 is a front view showing a toroidal coil formed by alpha winding.

FIG. 9 is a side view showing the toroidal coil formed by alpha winding.

FIG. 10 is a perspective view showing the toroidal coil formed by alpha winding.

FIG. 11 is a perspective view showing, in an enlarged manner, a structure in the vicinity of both wire ends of the toroidal coil formed by alpha winding.

FIG. 12 is a perspective view showing a state in which three toroidal coils formed by alpha winding are arranged so as to be displaced from each other in a circumferential direction with one of the outer peripheral yoke parts being removed so as to make the inside visible.

FIG. 13 is an exploded perspective view showing a pair of claw poles and a toroidal coil.

FIG. 14 is a perspective view showing an inner peripheral stator part and an outer peripheral yoke with an interposed member being removed.

FIG. 15 is a perspective view showing the inner peripheral stator part and the outer peripheral yoke with the interposed member being removed.

FIG. 16 is a perspective view showing an example configuration including an inner peripheral stator part, an outer peripheral yoke and a toroidal coil, wherein engaging parts are formed on the outer peripheral yoke, and wherein catch parts that engage with the engaging parts are formed on the outer periphery of claw poles.

FIG. 17 is a perspective view showing the inner peripheral stator part and the outer peripheral yoke with the toroidal coil being removed from the state shown in FIG. 16.

FIG. 18 is a perspective view showing an inner peripheral stator part and a pair of semi-ring-like members before being brought into contact with the inner peripheral stator part.

FIG. 19 is a perspective view showing the inner peripheral stator part and the pair of semi-ring-like members brought into contact with the outer periphery of the inner peripheral stator part.

FIG. 20 is an exploded perspective view showing a toroidal coil, an interposed member and a pair of claw poles.

FIG. 21 is a perspective view showing a single-phase inner peripheral stator part formed by combining the toroidal coil, the interposed member and the pair of claw poles.

FIG. 22 is an exploded perspective view showing a polyphase claw pole motor including semi-ring-like members.

FIG. 23 is a perspective view showing a polyphase claw pole motor including the semi-ring-like members.

FIG. 24 is a diagram showing an assembly procedure of a polyphase claw pole motor.

FIG. 25 is a diagram showing a configuration example of a conventional polyphase claw pole motor.

### DESCRIPTION OF EMBODIMENTS

Preferred embodiments of the present invention will now be described below with reference to the attached drawings.

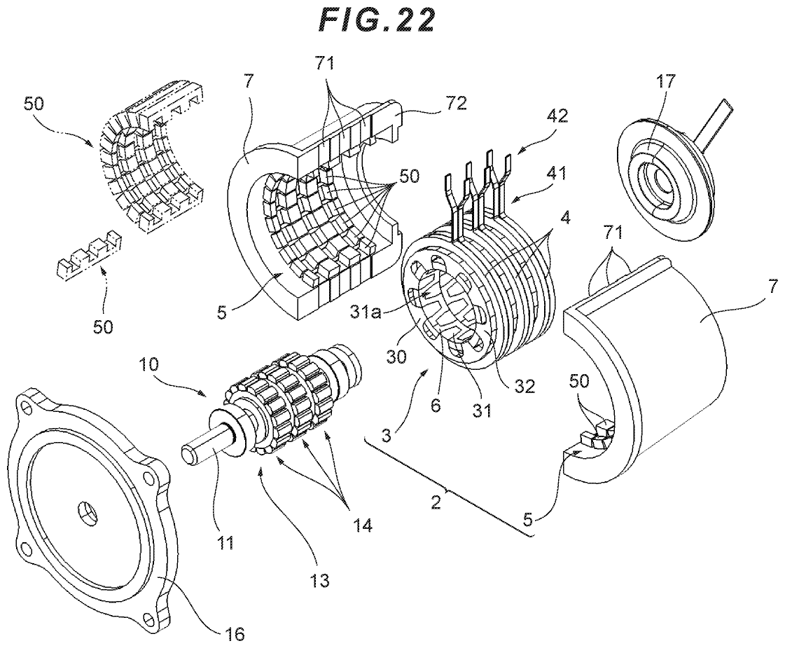

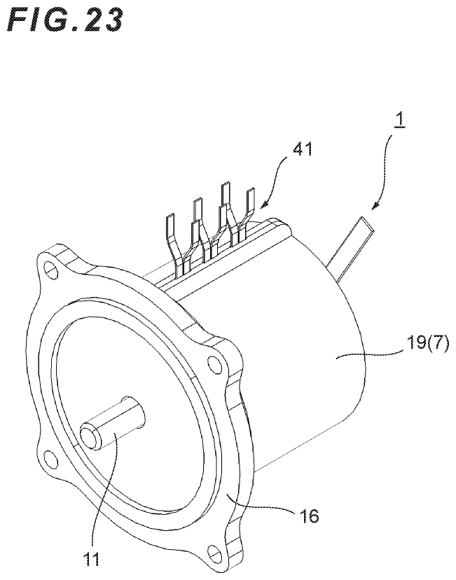

A polyphase claw pole motor 1 according to an embodiment of the present invention includes a stator (stator yoke) 2, a toroidal coil 4, a shaft 11 and others. The stator 2 includes: an inner peripheral stator part 3 constituted by claw poles 30; and an outer peripheral stator part 5 constituted by outer peripheral yokes 50. The claw poles 30 are each formed as a molded product obtained by compressing magnetic powder with the surface of such powder being electrically insulated, and the outer peripheral yokes 50 are each formed of soft magnetic laminated plates (see FIG. 22).

### First Embodiment

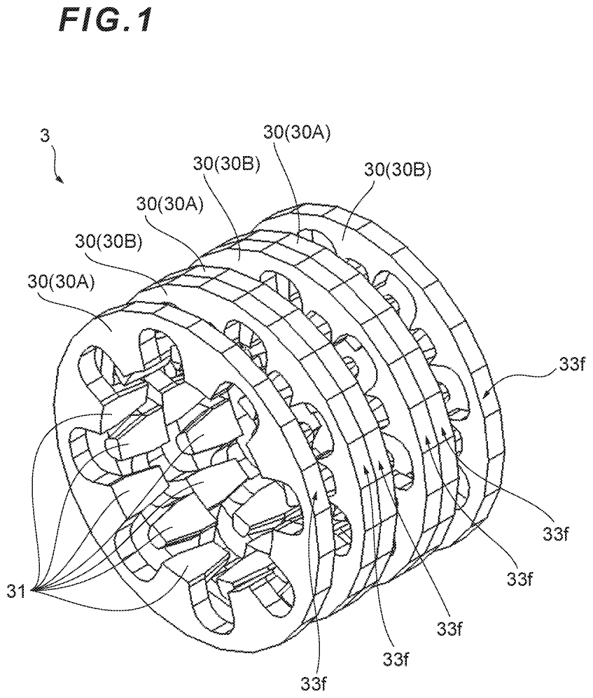

In the polyphase claw pole motor 1 according to the present embodiment, the claw pole 30 has claws 31, pole surfaces 31a and a radial yoke part 32 (see FIGS. 1, 4 and 5).

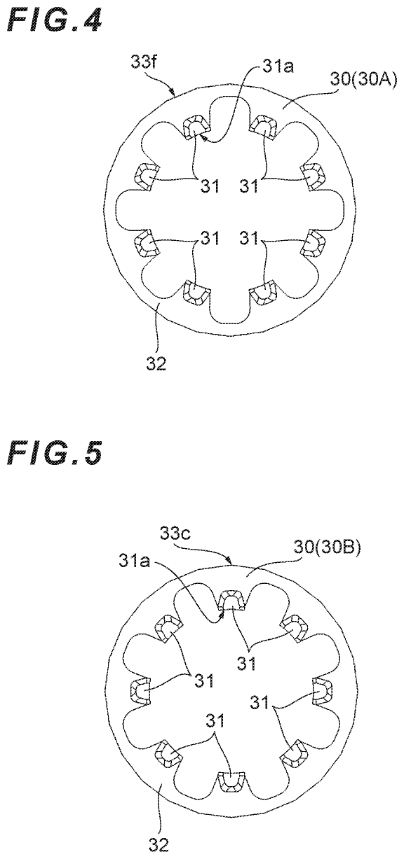

The claw 31 extends in an axial direction (which refers to the direction of a rotation axis of the shaft 11) and forms a claw pole. The claw 31 is provided with a pole surface 31a that faces an outer peripheral surface of a rotor core with a predetermined minute gap therebetween, the rotor core rotating along with the shaft 11. A plurality of claws (e.g., eight claws) 31 is formed in a single claw pole 30 (see FIGS. 1 and 4). The radial yoke part 32 is an annular portion extending from the claws 31 toward an outer contour (outer periphery) of the claw pole 30.

The plurality of claws 31 and the radial yoke part 32 are formed of a molded product (compressed-powder core) that is obtained by compressing magnetic powder with the surface of such powder being electrically insulated in order to increase a cross-sectional area of a magnetic path in the polyphase claw pole motor 1.

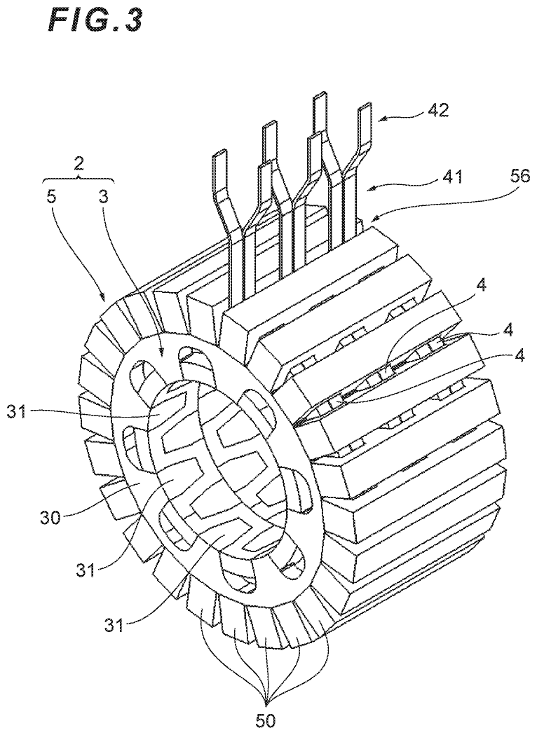

In the polyphase claw pole motor 1 according to the present embodiment, an outer peripheral stator part 5 is constituted by a plurality of outer peripheral yokes 50. The plurality of outer peripheral yokes 50 is circumferentially arranged at regular intervals on an outer side of the inner peripheral stator part (see FIG. 3).

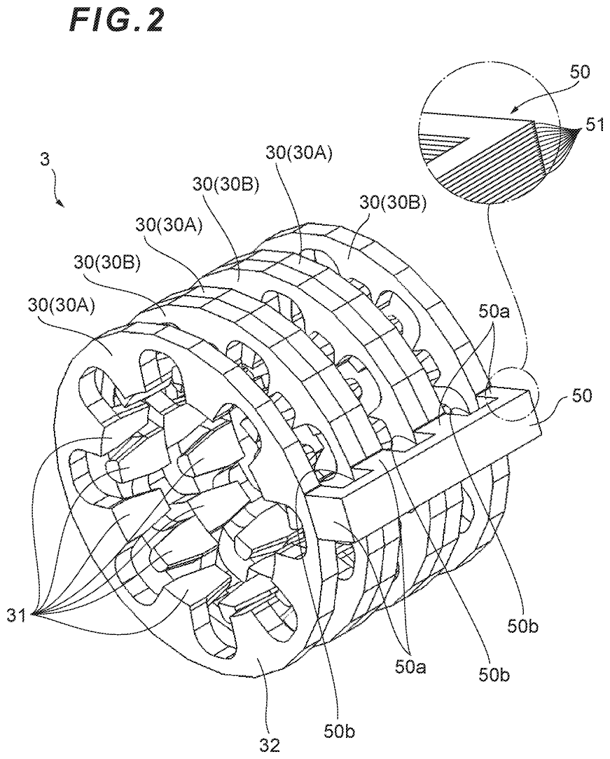

Each of the outer peripheral yokes 50 has a shape with parts thereof (projections 50a) extending radially inwardly so as to form grooves (recesses) 50b in which the toroidal coils 4 are received when the outer peripheral yoke 50 is arranged on the outer side of the inner peripheral stator part 3 (see FIG. 2). Radially extending portions of the outer peripheral yoke 50 overlap the toroidal coils 4 received in the grooves (recesses) 50b (see FIG. 3).

The outer peripheral yoke 50 also extends in the axial direction and preferably has a shape that allows itself to be in contact with the plurality of claw poles 30. The present embodiment employs the outer peripheral yoke 50 having a comb-like or fork-like shape including four projections 50a and three grooves 50b (see FIG. 2). Such outer peripheral yoke 50 has a length corresponding to an axial length of three pairs of claw poles 30 (i.e., six claw poles 30) constituting three phases, each pair including two facing claw poles 30 and constituting a single phase (see FIG. 2). By configuring the outer peripheral yoke 50 so as to be shared by two or more phases (three phases in the present embodiment) of the claw poles 30, it is possible to reduce the number of components and simplify the structure and assembly.

The outer peripheral yoke 50 is formed of a laminated core in which a plurality of comb-like or fork-like thin magnetic steel sheets 51 are laminated (see the section surrounded by the circle in FIG. 2). In a conventional-type stator yoke that is molded in an integral manner using a compressed-powder core, part of a portion constituting a radial yoke part (corresponding to a portion located on the radially outer side of the claw poles 30, i.e., the portion corresponding to the projection 50a, in the present embodiment) and a portion constituting an outer peripheral yoke, i.e., the portions excluding claw-shaped portions, are formed by a laminated core in which the non-directional magnetic steel sheets 51 are laminated in a tangential direction in a transverse section in the present embodiment, whereby a high-output and low-core loss polyphase claw pole motor 1 can be achieved at a low material cost.

More specifically, in the claw pole 109A formed of a compressed-powder core which has poor magnetic properties and which is likely to cause a low output, a high core loss and a high materials cost in Patent Document 1, a portion that can effectively increase an interlinkage magnetic flux is formed of a core of the non-directional magnetic steel sheets 51 to thereby achieve the polyphase claw pole motor 1 that is capable of satisfying both a high output and a low cost at a high level.

The outer periphery of the claw pole 30 preferably has a polygonal shape with surfaces which are to be in contact with the outer peripheral yoke 50 being flat surfaces. If an inner peripheral surface of the outer peripheral yoke 50 formed of the laminated core of the magnetic steel sheets 51 as described above is formed so as to be curved like an outer peripheral surface of a cylinder, the magnetic steel sheets 51 have to be arranged so as to form steps therebetween (so as to be displaced from each other), and it is difficult to bring the magnetic steel sheets 51 in close contact with the outer peripheral surfaces of the claw poles 30. In this regard, if the surfaces which are to be in contact with the outer peripheral yoke 50 are flat surfaces, the inner peripheral surface of the outer peripheral yoke 50 can be brought into close contact with such flat surfaces without any gap therebetween.

In the configuration in which the outer periphery of the claw pole 30 is formed in a polygonal shape, when the number of phases is three, the outer periphery of the claw pole 30 is preferably formed in a polygonal shape having three times as many sides as the number of the claws 31. In one example, the present embodiment employs two types of claw poles 30, each having eight claws 31 and an outer periphery of a regular 24-gon, the two types of claw poles 30 including: a claw pole 30A in which a portion on the radially outer side (rear side) of each claw 31 is a flat surface 33f including a side (see FIG. 4) and a claw pole 30B in which a portion on the radially outer side of each claw 31 is a corner 33c (a corner between the flat surfaces 33f) (see FIG. 5), and the claw poles 30A and 30B are combined so as to face each other as a pair with a displacement therebetween of 22.5° in a circumferential direction, the pair constituting a single phase, and a total of three pairs of such claw poles 30A and 30b are joined with a displacement of an electrical angle of 120° or a mechanical angle of 15° between each pair so as to form three phrase-claw poles 30. With such configuration, the projections 50a of the outer peripheral yoke 50 shared by the three phase-claw poles 30 can be brought into close contact with the flat surfaces 33f of all the claw poles 30 without any gap therebetween (see FIGS. 2 and 3).

The toroidal coil 4 is arranged on the outer side of the claw poles 30 and on the inner side of the outer peripheral yoke 50. In the polyphase claw pole motor 1 of the present embodiment, three toroidal coils 4 are arranged at regular intervals in the axial direction so as to correspond to the respective phases of the claw poles 30 (see FIG. 3). Each toroidal coil 4 is sandwiched by the projections 50a in the axial direction and enclosed by the claw poles 30 and the outer peripheral yoke 50 in the radial direction.

The stator 2 is formed such that 24 outer peripheral yokes 50 are circumferentially arranged around the inner peripheral stator part 3 and ends 42 of the wires 41 of the toroidal coils 4 are drawn out from gaps 56 between the outer peripheral yokes 50 (see FIG. 3). The gaps from which the wires 41 are drawn out extend in the axial direction.

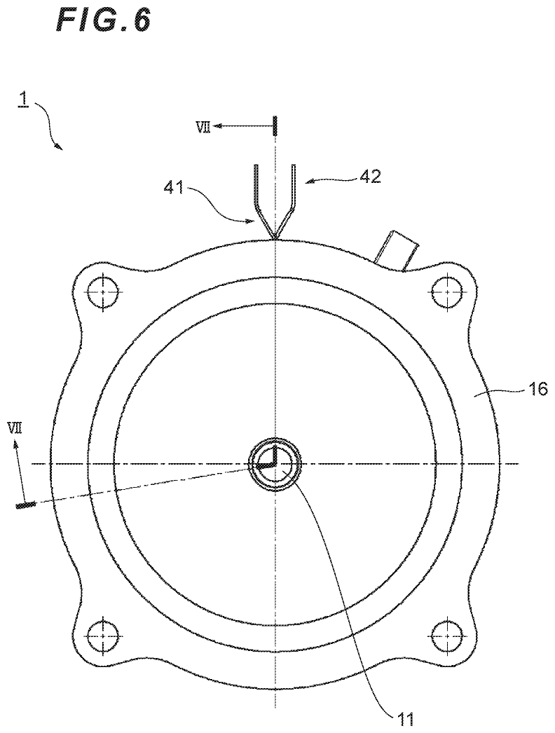

The polyphase claw pole motor 1 including the stator 2 having the above-described configurations is shown in FIGS. 6, 7, 22, etc. Further, the reference numerals in such figures denote the following components: 10 denotes a rotor, 12 denotes a bearing, 13 denotes a rotor core, 14 denotes permanent magnets, 15 denotes a sensor magnet, 16 denotes a front-surface bracket, 17 denotes a rear-surface bracket, 18 denotes a sensor, and 19 denotes a resin mold. Reference numeral 6 denotes an interposed member interposed between a pair of claw poles 30.

As described above, a portion of the radial yoke part (corresponding to the portion located on the radially outer side of the claw pole 30, i.e., the portion corresponding to the projection 50a, in the present embodiment embodiment) and a portion of the outer peripheral yoke, which have been formed of the compressed-powder core in the conventional claw pole, are formed of the laminated core constituted by the non-directional magnetic steel sheets 51 that are laminated in the tangential direction and the toroidal coil 4 is enclosed in the axial direction and the radial direction in the above embodiment. Such structure achieves the high-output and low-core loss polyphase claw pole motor 1 at a low material cost.

Furthermore, since side surfaces, which serve as a magnetic flux inflow surface and a magnetic flux outflow surface of the outer peripheral yoke 50 formed of the laminated core, are generally linear in the laminating direction, the portions (compressed-powder core surfaces) that are to be in contact with such linear surfaces in the outer periphery of the claw pole 30 are formed as segmented flat surfaces 33f so that the claw pole 30 has a generally polygonal shape as a whole in the above embodiment, whereby the outer peripheral yoke 50 and the claw pole 30 can be brought into close contact with each other without any gap therebetween.

### Second Embodiment

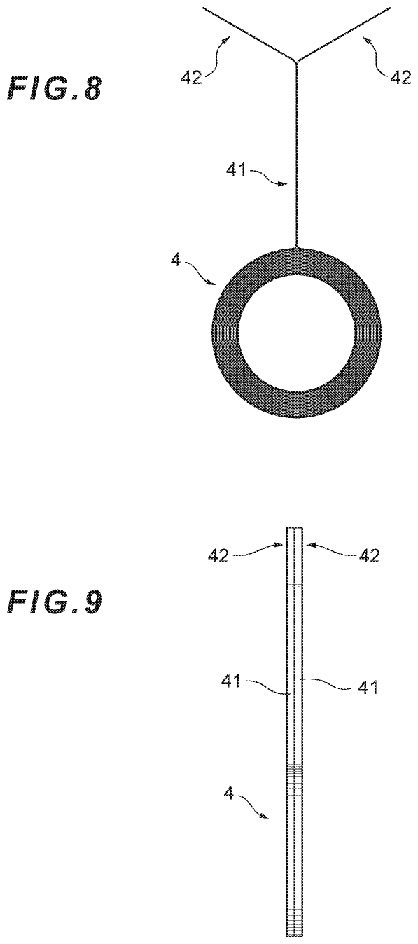

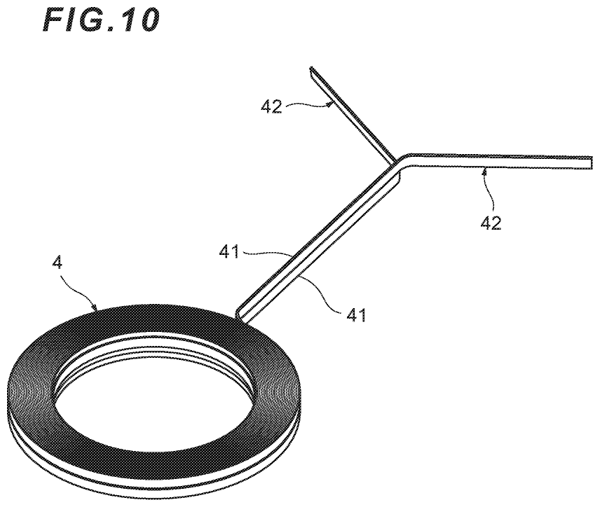

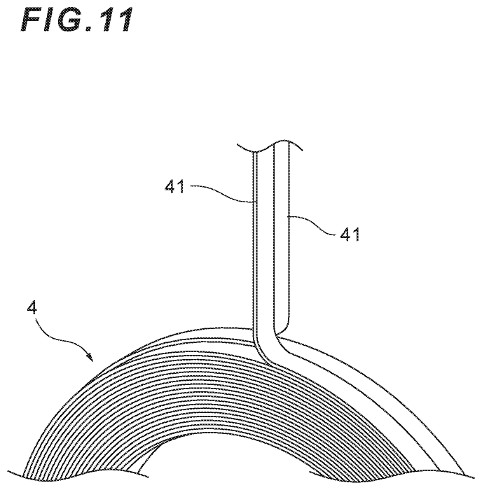

The present embodiment employs a toroidal coil 4 formed by alpha winding (see FIGS. 8-11). In the toroidal coil 4 formed by alpha winding, a copper wire is wound in a helical manner at the innermost turn of the coil, and two layers of the copper wire are wound in a whirlpool-like manner in opposite directions at the other part of the coil, so that both ends 42 of the wire 41 are located at the outermost turn of the coil (see FIGS. 10 and 11). A flat-type wire is employed as the wire 41, which can make it difficult to form a gap between adjacent portions of the wire 41 and increase the winding density of the wire 41.

In the toroidal coil 4 formed by alpha winding, since both ends 42 of the wire 41 are drawn out from the outermost turn of the toroidal coil 4, such structure does not require a space for the ends of the coil to be drawn out, which causes the cross-sectional area of a magnetic circuit to increase and makes the winding process simpler.

The alpha winding can be carried out by, for example, winding the innermost turn of the wire 41 in a helical manner, winding the other part of the wire 41 in a whirlpool manner in the opposite directions and, after completing winding to form a coil without a core, bonding the wound wire by heating (self-fusing flat-type wire alpha winding).

For example, for the polyphase claw pole motor 1 having three phases as in the present embodiment, three toroidal coils 4 formed by alpha winding may be provided so as to be displaced from each other in the circumferential direction.

The wire 41 in the present embodiment is a flat-type wire having different cross-sectional side lengths and such wire 41 is wound in a flatwise manner, i.e., the wire 41 is wound with its cross-sectional longitudinal direction being oriented in the axial direction. In general, wire ends from a coil have to be extended through a gap between outer peripheral yokes toward the outer periphery. However, the cross-sectional area of the magnetic paths of the outer peripheral yokes are required to be increased as much as possible in order to reduce the magnetic resistance, and the gap between the outer peripheral yokes is preferably small. Under such circumstances, since the present embodiment employs the toroidal coils 4 formed by alpha winding and flatwise winding with the cross-sectional longitudinal direction of each wire being oriented in the axial direction, wire ends (of the wire 41) from the coil are arranged so as to be aligned in the axial direction (see FIGS. 10 and 11), the wires can be extended through the gaps between the outer peripheral yokes with narrow cross-section arrangement in the tangential direction (in other words, a circumferential dimension of a cutout 34a in an outer peripheral yoke part 34 of the claw pole 30 is small), and the cross-sectional area of the wire can be secured. Therefore, a coil with a low copper loss as a whole can be provided.

### Third Embodiment

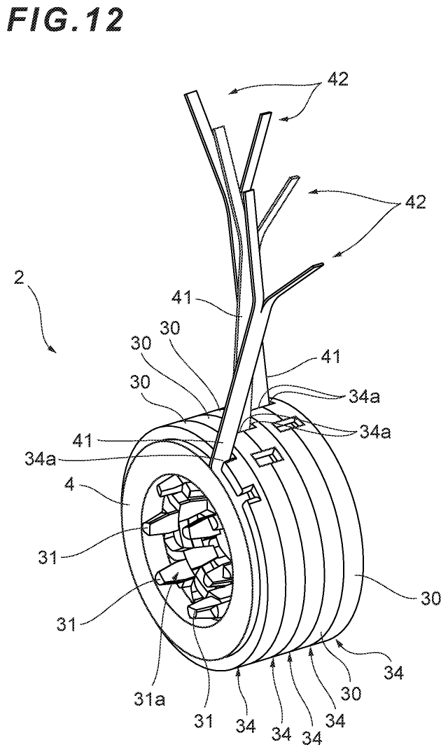

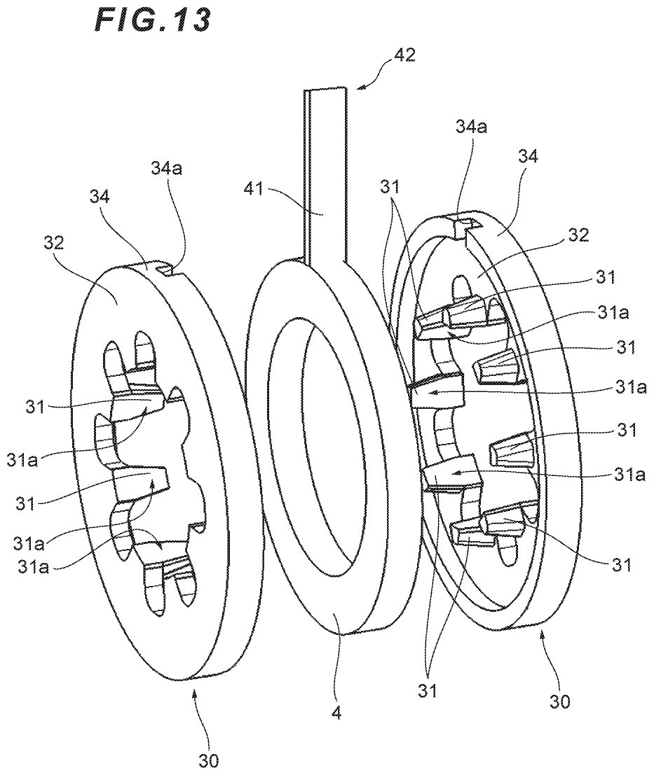

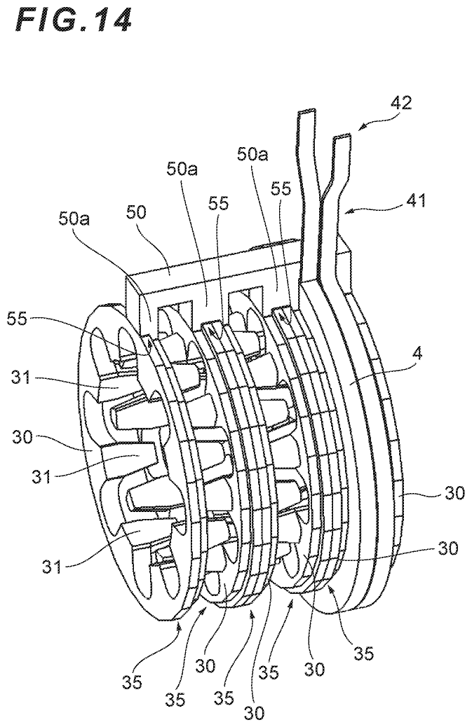

A claw pole motor 1 of the present embodiment includes claw poles 30 formed of magnetic-molded product formed by compressing magnetic power. Each of the claw poles 30 includes a plurality of claws 31, a plurality of claws 31 each having a pole surface 31a that extends in the axial direction and faces the rotator 10 with a minute gap therebetween, a radial yoke part 32 extending outward from the claws 31, and an outer peripheral yoke part 34 that extends in the axial direction (see FIGS. 12 and 13). The plurality of claw poles 30 are laminated in the axial direction so as to form a stator 2, with the plurality of claw poles 30 being arranged such that claws 31 of adjacent claw poles 30 are arranged in an alternating manner in the circumferential direction and radial yoke parts 32 in the adjacent claw poles 30 face each other in the axial direction.

The outer peripheral yoke part 34 of each claw pole 30 is provided with a cutout 34a for drawing out the wire 41 of the toroidal coil 4 toward the outer peripheral side. The cutouts 34a may be arranged such that the cutouts 34a of a pair of adjacent claw poles 30 face each other with the radial yoke parts 32 of such adjacent claw poles 30 facing each other in the axial direction, such that the cutouts 34a form a drawing hole of a size corresponding to the size of the wire 41 to be drawn out therefrom (see FIGS. 12 and 13).

The toroidal coils 4 are formed by alpha winding in the same way as the previous embodiment and arranged in gaps between radial yoke parts 32 of adjacent claw poles 30. A flat-type wire is used for the wire 41, and the wire 41 is drawn out from the drawing hole formed by a pair of cutouts 34 facing each other (see, FIGS. 12 and 13).

For example, for the polyphase claw pole motor 1 having three phases as in the present embodiment, three toroidal coils 4 formed by alpha winding are provided so as to be displaced from each other in the circumferential direction (see FIG. 12).

Even in the configuration in which the entire stator 2 is formed of a magnetic-molded product formed by compressing magnetic powder, as in the polyphase claw pole motor 1 of the present embodiment, by employing the toroidal coil 4 formed by alpha winding in the same way as the previous embodiment, the winding process can still be simplified with both ends 42 of the wire 41 being drawn out from the outermost turn of the toroidal coil 4.

### Fourth Embodiment

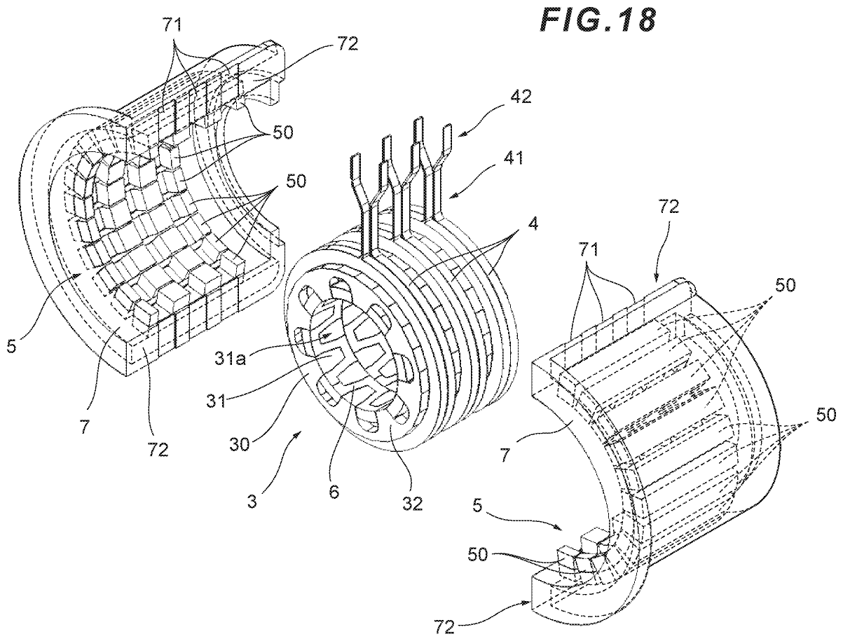

A polyphase claw pole motor 1 of the present embodiment includes members, e.g., semi-ring-like members 7, each functioning as a positioning means for positioning each of a plurality of outer peripheral yokes 50 at a predetermined position (see FIG. 18). The semi-ring-like members 7 are configured as a pair of members formed by dividing a cylindrical object along a longitudinal section into halves, the pair of semi-ring-like members 7 being arranged around the outer peripheral yokes 50 and combined with each other so as to form a ring-like resin mold 19 (see FIG. 23). When combined, the pair of semi-ring-like members 7 are configured so as to sandwich the claw poles 30 positioned by an interposed member 6 (to be described later) (see FIG. 22). The semi-ring-like members 7 of the present embodiment also constitute a bearing support structure for supporting a bearing 12.

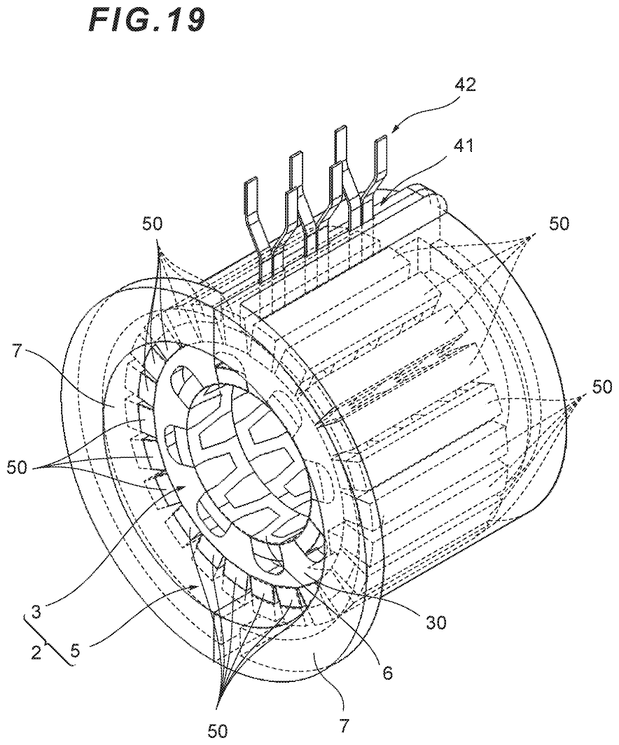

An inner periphery of the semi-ring-like member 7 is provided with arranging means such as, for example, flat surfaces, grooves, dents, partitions or a combination thereof, for arranging about half of the plurality of outer peripheral yokes 50 (e.g., 12 outer peripheral yokes) at predetermined positions in a fan-like or semi-ring-like arrangement around the stator 2. The arranging means may be molded, for example, on the inner peripheral side of the semi-ring-like member 7, simultaneously with when the semi-ring-like member 7 is molded from resin. The arranging means is formed so as to be in contact with the outer periphery and end surfaces (side surfaces) in the circumferential direction of each of the outer peripheral yokes 50. By arranging the plurality of outer peripheral yokes 50 on the inner periphery of each of the semi-ring-like members 7 and combining the pair of semi-ring-like members 7,7, all the outer peripheral yokes 50 can be arranged simultaneously at predetermined positions around the inner peripheral stator part 3 (see FIGS. 18 and 19). An insert-molded product including the outer peripheral yokes 50 as inserts may be employed as the semi-ring-like member 7.

One or both of the contact surfaces 72 that are in contact with each other in the circumferential direction when the pair of semi-ring-like members 7 are combined is or are provided with a drawing groove(s) 71 from which the wire 41 is drawn out (see FIGS. 18 and 19). The wire 41 extends through a gap 56 between the outer peripheral yokes 50 (see FIG. 3) and further extends through the drawing groove(s) 71 formed on the contact surfaces 72 of the semi-ring-like members 7 to the outside.

The semi-ring-like member 7 of the present embodiment are formed in a size that allows itself to house the inner peripheral stator part 3 formed by joining three pairs of facing claw poles 30, each pair constituting a single phase (i.e., the three pairs of claw poles 30 constituting three phases). The semi-ring-like members 7 are further configured such that a pair of such semi-ring-like members 7, when combined with each other, sandwich the inner peripheral stator part 3 in the vicinity of the center of the combined semi-ring-like members 7, with the inner peripheral stator part 3 including the claw poles 30 that are joined so as to constitute three phases.

The semi-ring-like members 7 described above are merely an example of a preferred member that functions as positioning means for positioning each of the plurality of outer peripheral yokes 50, and a member that is divided into thirds or quarters (in addition to a member that is divided into halves) in the circumferential direction may be employed, as long as such member is capable of providing a similar function.

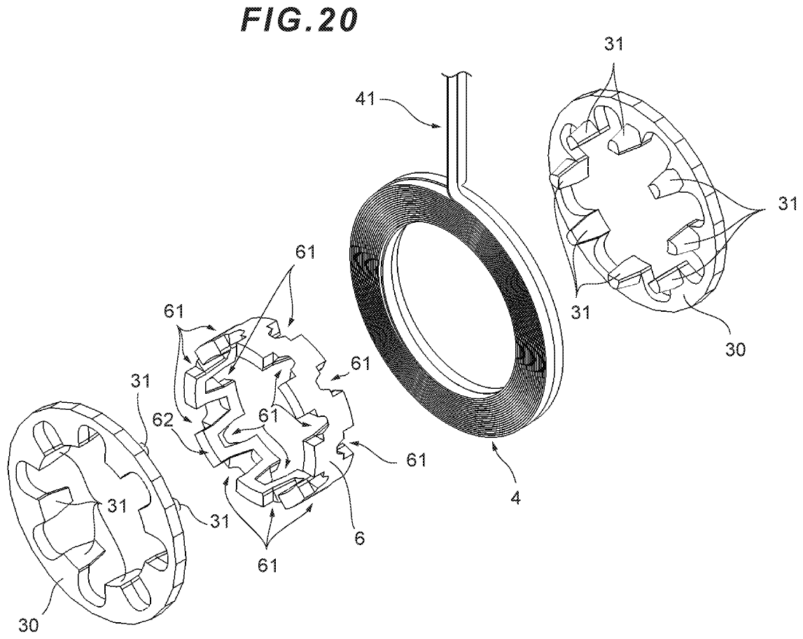

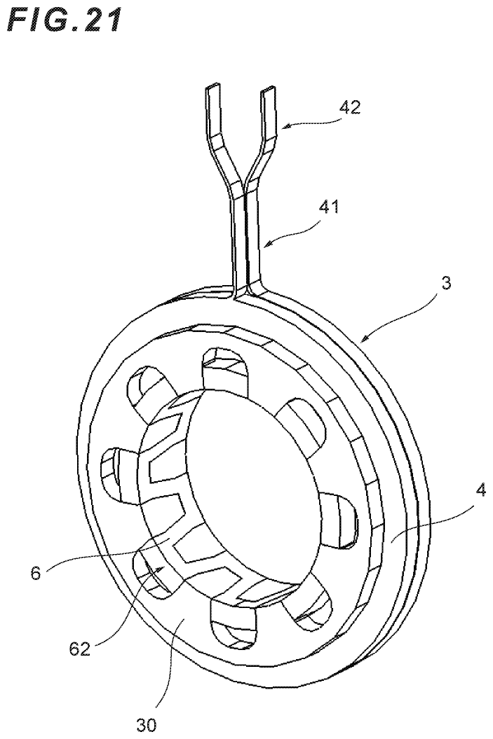

The polyphase claw pole motor 1 of the present embodiment includes an interposed member 6 that serves as positioning means for positioning the claw poles 30 in the axial direction (see FIG. 20, etc.). By interposing, for example, the cylindrical interposed member 6 between a pair of claw poles 30 that are joined so as to face each other so that the interposed member 6 receives magnetic attractive force, it is possible to achieve a configuration that can prevent unnecessary pressure from being applied to the toroidal coil 4 and other components.

Although the specific configuration of the interposed member 6 is not particularly limited as long as it has a configuration of receiving the magnetic attractive force so as to prevent an unnecessary pressure from being applied to the toroidal coil 4 and other components as described above, the interposed member 6 has a shape which allows itself to be located in a gap between at least part of the claws 31 of the claw poles 30 and such interposed member 6 positions the pair of claw poles 30 facing in the axial direction by being in contact with each of the claw poles 30. For example, the present embodiment employs the cylindrical interposed member 6 having claw receiving recesses 61 formed along the circumferential direction thereof, the claw receiving recesses 61 receiving the respective claws 31 of the pair of claw poles 30 whose claws 31 face each other (see FIG. 20, etc.). The interposed member 6 of the present embodiment is a non-magnetic and insulating resin-molded product. In such case, the interposed member 6 may be an insert-molded product including metal, etc., or an insert-molded product including the claw poles 30. The interposed member 6 configured as an insert-molded product including the claw poles 30 as inserts may be employed in a configuration in which the interposed member 6 is insert-molded with the alpha-winding toroidal coil 4 included therein or a configuration in which a wire is wound around the interposed member 6 after molding. The cylindrical interposed member 6 has an outer diameter corresponding to the size of a hollow portion in the toroidal coil 4. The inner peripheral stator part 3 constituting a single phase is formed by assembly with the interposed member 6 and toroidal coil 4 being sandwiched by the pair of claw poles 30 (see FIG. 21).

In the interposed member 6, an axial end surface 62 is formed between the adjacent claw receiving recesses 61, and the axial end surface 62 is exposed in the axial direction in the above-mentioned inner peripheral stator part 3 constituting a single phase (see FIGS. 20 and 21). When three inner peripheral stator parts 3, each constituting a single phase, are joined in the axial direction so as to constitute three phases, the adjacent interposed members 6 are in contact with each other via the axial end surfaces 62. In the configuration in which the adjacent interposed members 6 are in contact with each other, such interposed members 6 may be configured such that, for example, by joining the interposed members 6 with their respective projections and recesses (not shown) engaged with each other, the claw poles 30 in another layer are positioned with a displacement of a mechanical angle of 15°.

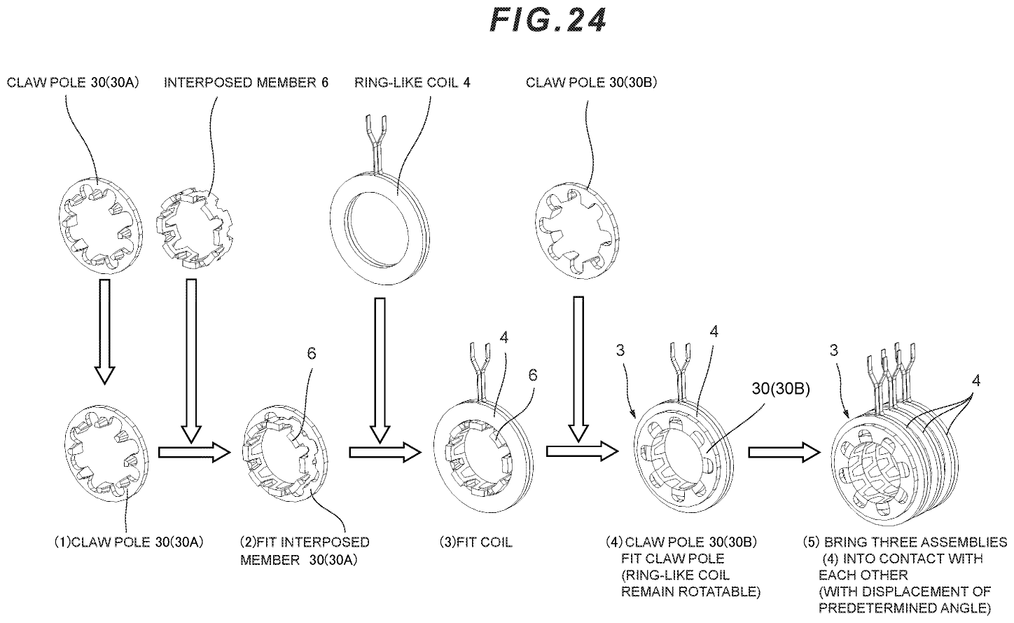

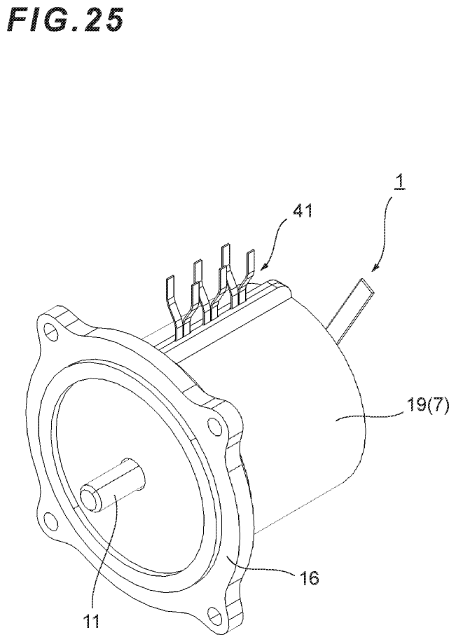

The following description will now describe assembly of the polyphase claw pole motor 1 of the present embodiment which has the above-mentioned semi-ring-like members 7 and interposed members 6 (see FIG. 24).

(1) One of a pair of claw poles 30 (e.g., the claw pole 30A) is prepared (see FIGS. 24(1)), and (2) the interposed member 6 is fitted with the prepared claw pole 30 on the claw 31 side (see FIG. 24(2)). (3) The toroidal coil 4 is further fitted with the interposed member 6 (see FIGS. 24(3)), and (4) the other one of the pair of claw poles 30 is fitted with the toroidal coil 4 to thereby form the inner peripheral stator part 3 constituting a single phase (see FIGS. 20, 21 and 24(4)). In this state, the toroidal coil 4 is rotatable relative to the pair of claw poles 30 and the interposed member 6. (5) Three inner peripheral stator parts 3, each constituting a single phase as described above, are brought into contact with each other with a displacement of a predetermined angle in a circumferential direction to thereby form the inner peripheral stator parts 3 constituting three phases (see FIG. 24(5)).

The plurality of claw poles 30 are arranged at predetermined positions on the inner periphery of each of a pair of semi-ring-like members 7 (see FIGS. 18 and 22), and the semi-ring-like members 7 are combined with each other with the three-phase inner peripheral stator parts 3 sandwiched therebetween. During this process, each of the claw poles 3 is sandwiched by the pair of semi-ring-like members 7 while being positioned by the interposed member 6. Further, the outer peripheral yokes 50 constituting the outer peripheral stator part 5 are arranged at predetermined positions around the inner peripheral stator parts 3, whereby the stator 2 is formed (see FIG. 19, etc.).

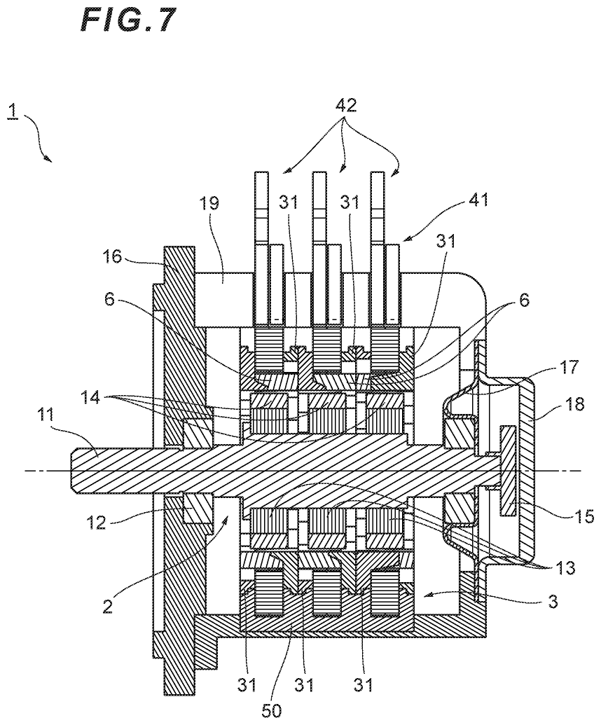

The polyphase claw pole motor 1 is assembled (see FIGS. 7 and 23) by attaching, to such stator 2, the shaft 11 with the rotor core 13 and the permanent magnets 14 attached thereto, the bearing 12, the rotor core 13, the sensor magnet 15, the front-surface bracket 16 and the rear-surface bracket 17 (see FIG. 22, etc.).

According to the polyphase claw pole motor 1 having the semi-ring-like members 7 as in the above embodiments, the semi-ring-like members 7 each having the plurality of outer peripheral yokes 50 arranged on the inner periphery thereof are set on the outer peripheral side of the inner peripheral stator parts 3, and it is therefore possible to simultaneously position the plurality of outer peripheral yokes 50 at the predetermined positions. With such configuration, even if each of the outer peripheral yokes 50 have a lot of components, it is still possible to prevent the assembly of such outer peripheral yokes 50 from being complicated.

Although the embodiments above are preferred examples of the present invention, the present invention is not limited to such embodiments and various modifications may be made without departing from the gist of the present invention. For example, although no particular mention has been made in the above embodiments, a surface of the projection 50a of the outer peripheral yoke 50, which is to be in contact with the outer periphery of the claw pole 30, may be provided with an engaging part 55, and an outer peripheral surface of the claw pole 30, which is to be in contact with the outer peripheral yoke 50, may be provided with a catch part 35 that engages with the engaging part 55 of the outer peripheral yoke 50, the catch part 35 extending along the extending direction of the claws 31 so as to be configured in an inner circumferentially engaging form. Such configuration may have the following effects.

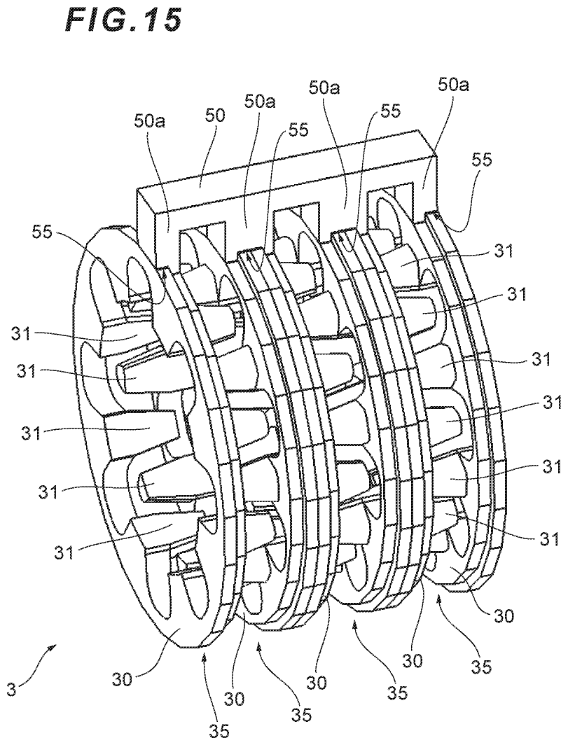

More specifically, a pair of claw poles (compressed-powder cores) 30 that are joined so as to face each other as described in the above embodiments apply magnetic attractive forces to each other. Although such magnetic attractive forces are cancelled out in the radial and circumferential directions, the magnetic attractive forces are applied as-is in the axial direction, instead of being cancelled out. Although the toroidal coil 4 is arranged between the claw poles 30 in the polyphase claw pole motor 1 of the present embodiment (see FIG. 14, etc.), it is not preferable for such toroidal coil 4 to support the attractive force in terms of insulation, etc. In this regard, by forming the catch parts 35 on the outer peripheral surface of each claw pole 30 and engaging the catch parts 35 with the engaging parts 55 of the outer peripheral yoke 50 so that a gap between the pair of claw poles 30 joined so as to face each other is restricted so as not to allow the claw poles 30 to approach each other beyond a predetermined distance as described above, it is possible to cause the attractive force to be supported by the outer peripheral yoke 50 instead of being applied to the toroidal coil 4. In other words, by making the outer peripheral yoke 50 function as a stopper (a spacing member) that regulates the minimum gap between the claw poles 30 to a size slightly larger than the thickness of the toroidal coil 4, it is possible to restrict the force to be applied to the toroidal coil 4.

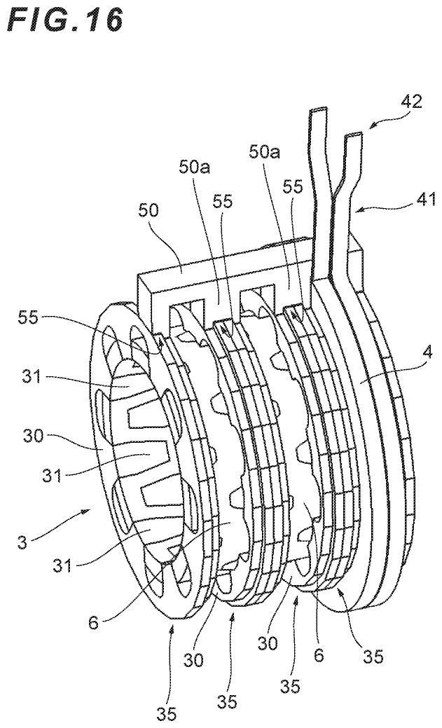

The specific structures of the catch parts 35 and the engaging parts 55 are not particularly limited, as long as they can engage with each other so as to hold the claw poles 30 with a predetermined gap therebetween. For example, the catch parts 35 may each have a tapered shape with an inclined surface that is inclined along the extending direction of the claws 31 so as to be configured in an inner circumferentially engaging form, or the catch parts 35 may each have a stepped shape as shown in FIGS. 14 and 15.

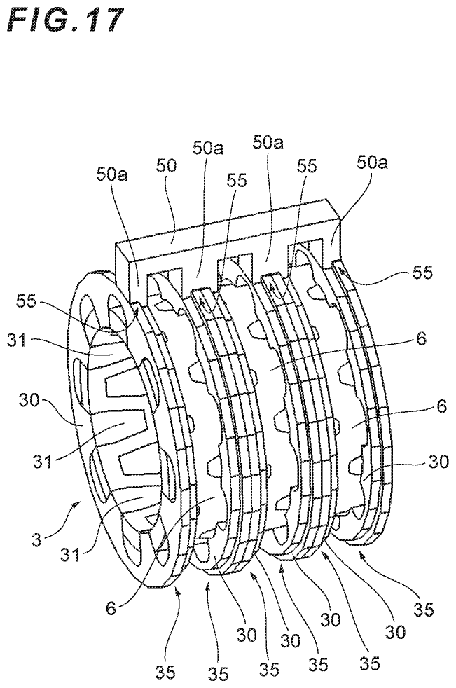

In the structure wherein the interposed member 6 is interposed between the pair of claw poles 30 that are joined so as to face each other and the interposed member 6 is used to receive the magnetic attractive force, the above-described catch parts 35 and engaging parts 55 may additionally be provided so that the magnetic attractive force to be received by the interposed member 6 can be reduced by sharing it with the plurality of outer peripheral yokes 50 (see FIGS. 16 and 17).

### INDUSTRIAL APPLICABILITY

The present invention is suitable for application to a polyphase claw pole motor, various types of industrial machines or various types of drive devices such as electric power steering that uses such motor as a driving source, and a vehicle equipped with the above-mentioned motor and machine or device.

### REFERENCE SIGNS LIST

1 . . . polyphase claw motor, 2 . . . stator, 3 . . . inner peripheral stator part, 4 . . . toroidal coil, 5 . . . outer peripheral stator part, 6 . . . interposed member (second positioning means), 7 . . . semi-ring-like member (first positioning means), 10 . . . rotator, 11 . . . shaft, 12 . . . bearing, 30 . . . claw pole (magnetic-molded product), 31 . . . claw, 31a . . . pole surface, 32 . . . radial yoke part, 41 . . . wire, 42 . . . wire end, 50 . . . outer peripheral yoke, 61 . . . claw receiving recess, 71 . . . drawing groove (groove), 72 . . . contact surface

1. A polyphase claw pole motor, comprising:
a plurality of claw poles each having a plurality of claws having a pole surface that extends in an axial direction and faces a rotator with a minute gap therebetween, and a radial yoke part that extends from the claws toward an outer contour of the claw pole, the claw poles being laminated in the axial direction so as to form an inner peripheral stator part with the respective claws of adjacent claw poles being alternately arranged in a circumferential direction and the respective radial yoke parts of the adjacent claw poles facing each other in the axial direction;
a toroidal coil arranged in a gap between the respective yoke parts of the adjacent claw poles; and
a plurality of outer peripheral yokes circumferentially arranged on an outer side of the inner peripheral stator part so as to form an outer peripheral stator part,
wherein the claw poles are each formed of a magnetic-molded product formed by compressing magnetic powder with a surface of such powder being electrically insulated, and the outer peripheral yokes are each formed of soft magnetic laminated plates, and
wherein the polyphase claw pole motor further comprises first positioning means for positioning each of the outer peripheral yokes at a predetermined position.

2. The polyphase claw pole motor according to claim 1, further comprising second positioning means for positioning each of the claw poles at a predetermined position.

3. The polyphase claw pole motor according to claim 2, wherein the second positioning means is an interposed member located in a gap between at least part of claw shapes of the claw poles, the interposed member positioning the claw poles by being in contact with each claw that faces each other in the axial direction.

4. The polyphase claw pole motor according to claim 3, wherein the interposed member is a non-magnetic and insulating member.

5. The polyphase claw pole motor according to claim 3, wherein the interposed member is an insert-molded product including the magnetic-molded product as an insert.

6. The polyphase claw pole motor according to claim 5, wherein the toroidal coil is a coil formed by alpha winding and the interposed member is an insert-molded product including the toroidal coil as an insert.

7. The polyphase claw pole motor according to claim 5, wherein the toroidal coil is configured from a wire wound around the insert-molded product.

8. The polyphase claw pole motor according to claim 3, wherein the interposed member has a structure in which, in a state where adjacent interposed members are in contact with each other, the interposed members position the magnetic-molded product of another layer.

9. The polyphase claw pole motor according to claim 2, wherein the first positioning means is in contact with an outer periphery and circumferential end surfaces of each of the plurality of outer peripheral yokes, the first positioning means has a shape that defines part of a ring-like shape, and a plurality of such first positioning members are combined with each other to form the ring-like shape.

10. The polyphase claw pole motor according to claim 9, wherein the plurality of first positioning means, when combined with each other, sandwich the magnetic-molded product in the vicinity of a center thereof, the magnetic-molded product being positioned by the second positioning means.

11. The polyphase claw pole motor according to claim 10, wherein the plurality of first positioning means each have a shape that allows approximately half the plurality of outer peripheral yokes to be positioned and arranged in a semi-ring-like form and a pair of the first positioning means are combined so as to sandwich the magnetic-molded product positioned by the second positioning means.

12. The polyphase claw pole motor according to claim 9, wherein contact portions in a circumferential direction of the combined first positioning means are provided with a groove and a coil lead wire from the toroidal coil is drawn out from the groove.

13. The polyphase claw pole motor according to claim 9, wherein the first positioning means is a component of a bearing support structure for supporting a bearing.

14. The polyphase claw pole motor according to claim 1, wherein an outer peripheral surface of the claw pole which is to be in contact with the outer peripheral yoke extends along an extending direction of the claws and has a constricting shape that is tapered or stepped so as to form an inner circumferentially engaging form.
